(19) United States
(12) Patent Application Publication
(10) Pub. No.: US 2025/0102379 A1
(43) Pub. Date: Mar. 27, 2025

(54) STRAIN GAUGE, METHOD FOR PRODUCING STRAIN GAUGE, AND STRAIN SENSOR

(71) Applicant: Alps Alpine Co., Ltd., Tokyo (JP)

(72) Inventors: Yosuke IDE, Niigata-ken (JP); Masakazu SERA, Niigata-ken (JP); Tatsuya SAITO, Niigata-ken (JP); Sakiko YAMANOBE, Niigata-ken (JP)

(21) Appl. No.: 18/969,834

(22) Filed: Dec. 5, 2024

Related U.S. Application Data
(63) Continuation of application No. PCT/JP2023/007229, filed on Feb. 28, 2023.

(30) Foreign Application Priority Data
Jul. 8, 2022 (JP) 2022-110658

(51) Int. Cl. G01L 1/22

(52) U.S. Cl. CPC G01L 1/2268; G01L 1/2287

(57) ABSTRACT

A strain gauge according to an embodiment of the present invention includes a strain gauge having a pattern of a laminate including a strain resistance layer and a protective layer having a portion in contact with the strain resistance layer, the protective layer being electrochemically more noble than the strain resistance layer. Thus, when wet etching is performed to form the pattern of the laminate, the protective layer is not easily etched in the vicinity of the strain resistant layer. This inhibits resist pattern peeling or the like, reducing variations in the amount of undercut.

### CLAIM OF PRIORITY

This application is a Continuation of International Application No. PCT/JP2023/007229 filed on Feb. 28, 2023, which claims benefit of Japanese Patent Application No. 2022-110658 filed on Jul. 8, 2022. The entire contents of each application noted above are hereby incorporated by reference.

### BACKGROUND OF THE INVENTION

### 1. Field of the Invention

The present invention relates to a strain gauge, a method for producing a strain gauge, and a strain sensor.

### 2. Description of the Related Art

A strain gauge, which is attached to a measurement target (strain-generating body) to detect its strain, is known. As a constituent material of such a strain gauge, a strain resistor whose resistance changes with a volume change caused by an external force is exemplified. Specifically, a metal-based material containing Ni, Cr, Cu, or the like is used. The strain resistor is formed, for example, in the form of a film on a substrate, and is then formed into a desired pattern, such as a meandering pattern, by photolithography and etching techniques (see, for example, Japanese Unexamined Patent Application Publication Nos. 2016-74934 and 2017-161286).

As described in Japanese Unexamined Patent Application Publication No. 2017-161286, when the pattern of the strain resistor is formed, the resistance value of the strain gauge inevitably varies due to variations that occur in the photolithography step and variations that occur in the etching step. For this reason, in the technique disclosed in Japanese Unexamined Patent Application Publication No. 2017-161286, the strain gauge is provided with a resistive wiring pattern for adjusting the resistance.

However, when such a resistive wiring pattern is provided, it is difficult to reduce the size of the strain gauge. Reducing the size of the measurement target (strain-generating body) makes it difficult to perform accurate measurement unless the area where the strain gauge is attached is reduced. Thus, with the technology disclosed in Japanese Unexamined Patent Application Publication No. 2017-161286, it is difficult to accurately measure the strain of a small strain-generating body.

In light of the above circumstances, the present invention provides a strain gauge with only small variations in resistance and a method for producing the strain gauge. The present invention also provides a strain sensor including the strain gauge and configured to enable high-accuracy strain measurement even when a strain-generating body is small.

### SUMMARY OF THE INVENTION

In response to the above issue, one aspect of the present invention is directed to providing a strain gauge including a strain gauge having a pattern of a laminate including a strain resistance layer and a protective layer having a portion in contact with the strain resistance layer, the protective layer being electrochemically more noble than the strain resistance layer.

As described above, since the protective layer is electrochemically more noble than the strain resistance layer, when wet etching is performed to form the pattern of the laminate, the protective layer is not easily etched in the vicinity of the strain resistance layer. This inhibits resist pattern peeling or the like, reducing variations in the amount of undercut.

In the above strain gauge, the protective layer preferably has a higher resistivity than the strain resistance layer. In this case, a current is less likely to flow in the protective layer, enabling an increase in the strain detection sensitivity of a strain sensor.

In the above-mentioned strain gauge, the protective layer is preferably etchable with an etching solution for etching the strain resistance layer. In the present specification, “etchable” indicates that an etch rate that can be industrially used in wet etching is obtained. Specifically, the etch rate is preferably 1 nm/min or more, more preferably 3 nm/min or more. The upper limit of the etch rate of the protective layer is not specified. However, when the etch rate of the protective layer is measured alone (that is, the protective layer and the strain resistance layer are not electrically coupled to each other), the etch rate of the protective layer is preferably lower than that of the strain resistance layer.

In the above-mentioned strain gauge, the strain resistance layer may contain one or more first elements selected from the group consisting of Ni, Cr, and Cu, and the protective layer may contain one or more second elements selected from the group consisting of Ni and Cr, and a third element having a first ionization energy higher than an element with the highest content (unit: at %) among the first elements in the strain resistance layer. In this case, it is easier to provide the protective layer that is electrochemically more noble than the strain resistance layer.

In the above-mentioned protective layer, the amount of the third element contained may be preferably 50 at. % or less from the viewpoint of achieving the appropriate etchability of the protective layer. In the above-mentioned protective layer, the amount of the third element contained is preferably 10 at. % or more from the viewpoint of stably achieving the reduction of the variations in the amount of undercut.

The third element may contain a metalloid element or a main-group element. In this case, it is easy to provide the protective layer having a higher resistivity than the strain resistance layer. The third element may contain one or more elements selected from the group consisting of B, C, Si, P, and Ge. When the third element contains one or more of these elements, the protective layer having a higher resistivity than the strain resistance layer may be provided more stably.

The third element may have a Pauling electronegativity of 2.6 or less. An electronegativity of 2.6 or less may be preferable in terms of the protective layer having appropriate etchability.

The first element may contain Cr, and the strain resistance layer may further contain a main-group element. The strain resistance layer may preferably have a resistivity of 100 μΩcm or less and a lower resistivity than the protective layer.

Another aspect of the present invention is directed to providing a strain sensor including the above-mentioned strain gauge and an electrode for energizing the strain gauge.

Another aspect of the present invention is directed to providing a method for producing a strain gauge including a pattern of a laminate including a strain resistance layer and a protective layer disposed on at least a portion of the strain resistance layer and electrochemically more noble than the strain resistance layer. In the production method, the pattern of the laminate is formed by including forming the protective layer on the strain resistance layer disposed on a substrate, forming a resist pattern on a portion of the protective layer, and removing by wet etching a portion of the protective layer not covered with the resist pattern and a portion of the strain resistance layer located below the portion of the protective layer not covered with the resist pattern.

In the above-mentioned production method, the etch rate of the strain resistance layer in an etching solution used for the wet etching may be preferably 50 nm/min or more.

In the above-described production method, the etch rate of the protective layer in the etching solution used for the wet etching may be preferably 5 nm/min or more.

### BRIEF DESCRIPTION OF THE DRAWINGS

FIG. 1 illustrates an example of a strain sensor according to an embodiment of the present invention;

FIG. 2 is a schematic cross-sectional view taken along line II-II in FIG. 1;

FIG. 3A is an explanatory view of a method for producing a strain gauge according to an embodiment of the present invention and illustrates a state in which a strain resistance layer and a protective layer are laminated;

FIG. 3B is an explanatory view of the method for producing a strain gauge according to an embodiment of the present invention and illustrates a state in which a resist film is formed;

FIG. 3C is an explanatory view of the method for producing a strain gauge according to an embodiment of the present invention and illustrates a state in which a resist pattern is formed;

FIG. 3D is an explanatory view of the method for producing a strain gauge according to an embodiment of the present invention and illustrates a state in which the protective layer is being etched;

FIG. 3E is an explanatory view of the method for producing a strain gauge according to an embodiment of the present invention and illustrates a state in which the protective layer is etched to expose the strain resistance layer;

FIG. 3F is an explanatory view of the method for producing a strain gauge according to an embodiment of the present invention and illustrates a state in which the strain resistance layer is being etched;

FIG. 3G is an explanatory view of the method for producing a strain gauge according to an embodiment of the present invention and illustrates a state in which etching of the strain resistance layer is completed;

FIG. 3H is an explanatory view of the method for producing a strain gauge according to an embodiment of the present invention and illustrates a state in which the resist pattern is removed;

FIG. 4A is an explanatory view of a method for producing a strain gauge according to the related art and illustrates a state in which a strain resistance layer is laminated;

FIG. 4B is an explanatory view of the method for producing a strain gauge according to the related art and illustrates a state in which a resist film is formed;

FIG. 4C is an explanatory view of the method for producing a strain gauge according to the related art and illustrates a state in which a resist pattern is formed;

FIG. 4D is an explanatory view of the method for producing a strain gauge according to the related art and illustrates a state in which the strain resistance layer is being etched;

FIG. 4E is an explanatory view of the method for producing a strain gauge according to the related art and illustrates a state in which etching of the strain resistance layer is completed;

FIG. 4F is an explanatory view of the method for producing a strain gauge according to the related art and illustrates a state in which the resist pattern is removed;

FIG. 5 is a graph illustrating the mean value and 3σ of the amounts of undercut of strain resistance layer produced in Example 1;

FIG. 6 is a graph illustrating 3σ of the amounts of undercut of the strain resistance layer produced in Example 1;

FIG. 7 is a graph illustrating the mean interelectrode resistance of the strain gauges produced in Example 1;

FIG. 8 is a graph illustrating the variation index of the interelectrode resistances of the strain gauges produced in Example 1;

FIG. 9 is a graph illustrating the mean value and 3σ of the amounts of undercut of strain resistance layer produced in Example 2; and

FIG. 10 is a graph illustrating 3σ of the amounts of undercut of the strain resistance layer produced in Example 2.

### DESCRIPTION OF THE PREFERRED EMBODIMENTS

Embodiments of the present invention will be described below with reference to the drawings. In the following description, the same members are designated using the same reference numerals, and duplicate description of the members that have been explained once is omitted as appropriate.

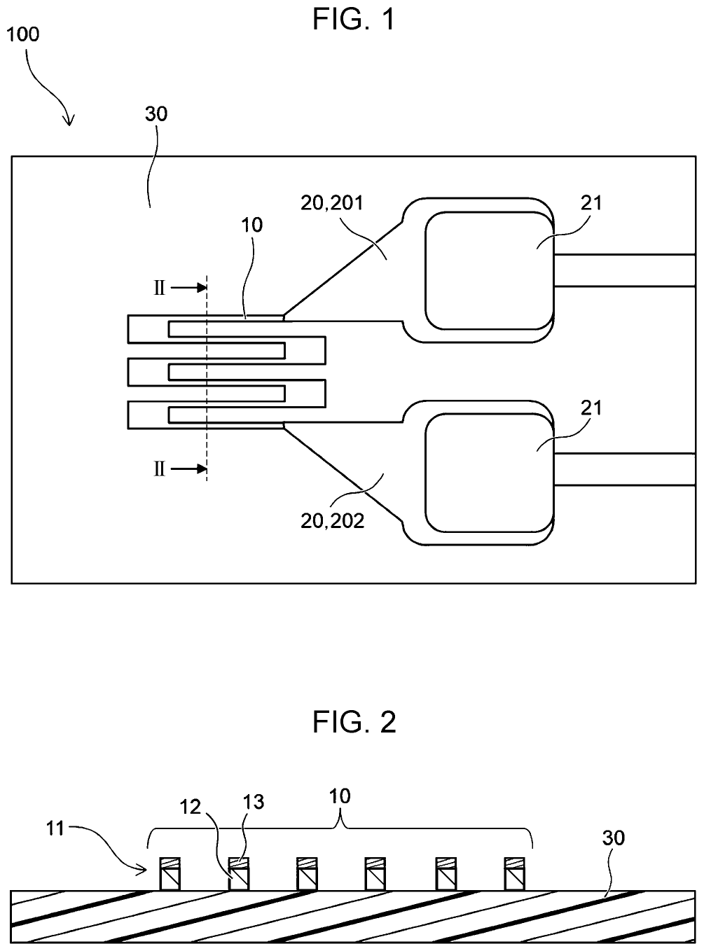

FIG. 1 illustrates an example of a strain sensor according to an embodiment of the present invention. As illustrated in FIG. 1, a strain sensor 100 according to the present embodiment includes a strain gauge 10 having a meandering pattern, and electrodes 20 for energizing the strain gauge 10. The strain gauge 10 and the electrodes 20 are all disposed on a substrate 30. Non-limiting examples of a constituent material of the electrodes 20 include Cu, Au, and alloys containing these. The electrodes 20 include a first electrode 201 connected to one end portion of the strain gauge 10 and a second electrode 202 connected to the other end portion. Each of the first electrode 201 and the second electrode 202 is provided with a plating 21 for the purpose of increasing the solder joint strength.

FIG. 2 is a schematic cross-sectional view taken along line II-II in FIG. 1. As illustrated in FIG. 2, the strain gauge 10 includes a laminate 11 including a strain resistance layer 12 and a protective layer 13 having a portion in contact with the strain resistance layer 12. The laminate 11 has a meandering pattern.

The strain resistance layer 12 has the property that its resistance value changes when its length changes in the direction of current flow due to external force. This property can be quantitatively evaluated by a gauge factor Gf described in the following formula (1):

Gf=(ΔR/R)/(ΔL/L) (1)

where L is the length of the strain gauge 10 in the direction in which a current flows (the length in the current direction) with no external force applied (under no-load conditions), ΔL is the amount of change in the length of the strain gauge 10 in the current direction with an external force applied to the strain gauge 10 (under load conditions) with respect to that under no-load conditions, R is the resistance value of the strain gauge 10 under no-load conditions, and ΔR is the amount of change in the resistance value of the strain gauge 10 under load conditions with respect to that under no-load conditions.

The strain resistance layer 12 is composed of a metallic material containing, for example, Ni, Cr, or Cu as a main component. Typical examples of such a material include NiCr₂₀ (Nichrome, resistivity: 104 μΩcm) and CuNi₄₅ (Constantan, resistivity: 48 μΩcm). The resistivity of the strain resistance layer 12 is preferably low. For example, the resistivity is preferably, but not necessarily, 100 μΩcm or less.

From the viewpoint of improving the balance between the gauge factor Gf and the temperature coefficient of resistance (TCR), the strain resistance layer 12 may preferably contain, for example, Cr as a main component and a nonmetallic element, specifically, a main-group element (for example, N).

The strain gauge 10 according to the present embodiment includes the laminate 11 in which the protective layer 13 is disposed on the strain resistance layer 12. The protective layer 13 is electrochemically more noble than the strain resistance layer 12. Since the protective layer 13 having such characteristics, variations in the amount of undercut when the strain resistance layer 12 is wet-etched are inhibited. This will be described in detail when a method for producing the strain gauge 10 is described.

Any material constituting the protective layer 13 can be used as long as it is electrochemically more noble than the strain resistance layer 12. However, the resistivity (unit: Ωcm) of the protective layer 13 is preferably higher than the resistivity of the strain resistance layer 12 in such a manner that a current flows preferentially through the strain resistance layer 12 when the laminate 11 including the strain resistance layer 12 and the protective layer 13 is energized. For example, in view of the resistivity of the above-mentioned NiCr₂₀ (Nichrome) and CuNi₄₅ (Constantan), the protective layer 13 preferably has a resistivity of at least 50 μΩcm or more, more preferably 120 μΩcm or more, and particularly preferably 150 μΩcm or more.

As will be described below in the method for producing the strain gauge 10, when the laminate 11 is patterned by wet etching, the protective layer 13 should be etchable with an etching solution used to etch the strain resistance layer 12.

The strain resistance layer 12 of the strain gauge 10 may contain one or more first elements selected from the group consisting of Ni, Cr, and Cu. In this case, the protective layer 13 preferably contains one or more second elements selected from the group consisting of Ni and Cr, and a third element having a first ionization energy higher than an element having the highest content (unit: at. %), among the first elements in the strain resistance layer 12. This makes it easier to achieve the fact that the protective layer 13 is electrochemically more noble than the strain resistance layer 12.

The first ionization energy is 737.1 kJ/mol for Ni, 652.9 kJ/mol for Cr, and 745.5 kJ/mol for Cu. Therefore, an element with a first ionization energy of 750 kJ/mol or more is suitable as the third element. Such elements are commonly found among the metalloid elements and the main-group elements. Thus, the third element may preferably include a metalloid element or a main-group element. Non-limiting preferred examples of the third element include B (800.6 kJ/mol), C (1086.5 kJ/mol), Si (786.5 kJ/mol), P (1011.8 kJ/mol), and Ge (762 kJ/mol), where the first ionization energy is indicated in parentheses. Therefore, the third element preferably contains one or more elements selected from the group consisting of these elements.

When the protective layer 13 contains the second element and the third element as described above, the third element content is preferably 50 at. % or less from the viewpoint of easily ensuring etchability. The third element content is preferably 10 at. % or more from the viewpoint of stably achieving the reduction of the variations in the amount of undercut. As will be described in the following examples, at a third element content of about 25 at. %, even if the third element content is increased beyond that, the effect on the variations in the amount of undercut may be reduced.

The third element may have a Pauling electronegativity of 2.6 or less. When the electronegativity is 2.6 or less, the material constituting the protective layer 13 is less likely to have high ionic bond properties. Thus, the protective layer 13 having appropriate etchability may be more stably provided. An element with high electronegativity easily has multiple valences. For this reason, the composition and microstructure of the protective layer 13 may vary locally. Such variations may cause electrochemical variations and may affect the achievement of the function, that is, the reduction of the variations in the amount of undercut of the strain resistance layer 12, of the protective layer 13.

When both of the constituent material of the strain resistance layer 12 and the constituent material of the electrodes 20 contain Cu, for example, when the strain resistance layer 12 is composed of CuNi₄₅ (Constantan) and the electrodes 20 are composed of Cu, appropriate selection of the constituent material of the protective layer 13 enables the protective layer 13 to inhibit diffusion of Cu contained in the electrode 20 into the strain resistance layer 12. If Cu diffuses from the electrodes 20 into the strain resistance layer 12, the composition of the strain resistance layer 12 may change to decrease the gauge factor Gf of the strain gauge 10. The protective layer 13 having a Cu barrier function is easily obtained when the second element and the third element described above are contained, and is particularly easily obtained by selecting a metalloid element or a main-group element as the third element.

A method for producing the strain gauge 10, specifically, a method for forming a pattern of the laminate 11 included in the strain gauge 10, will be described below.

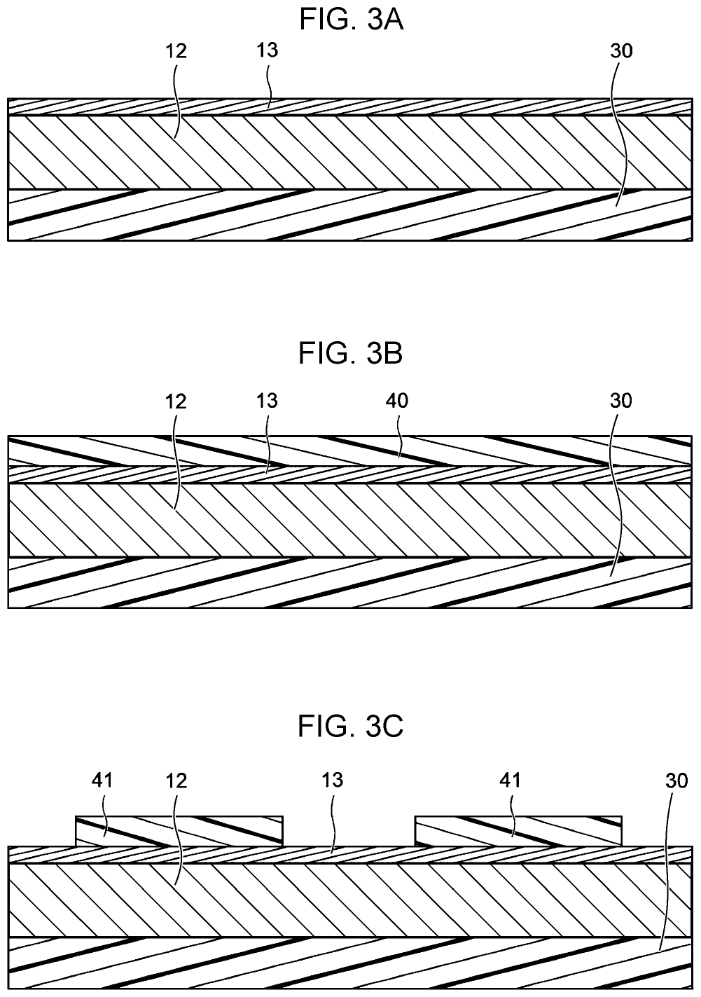

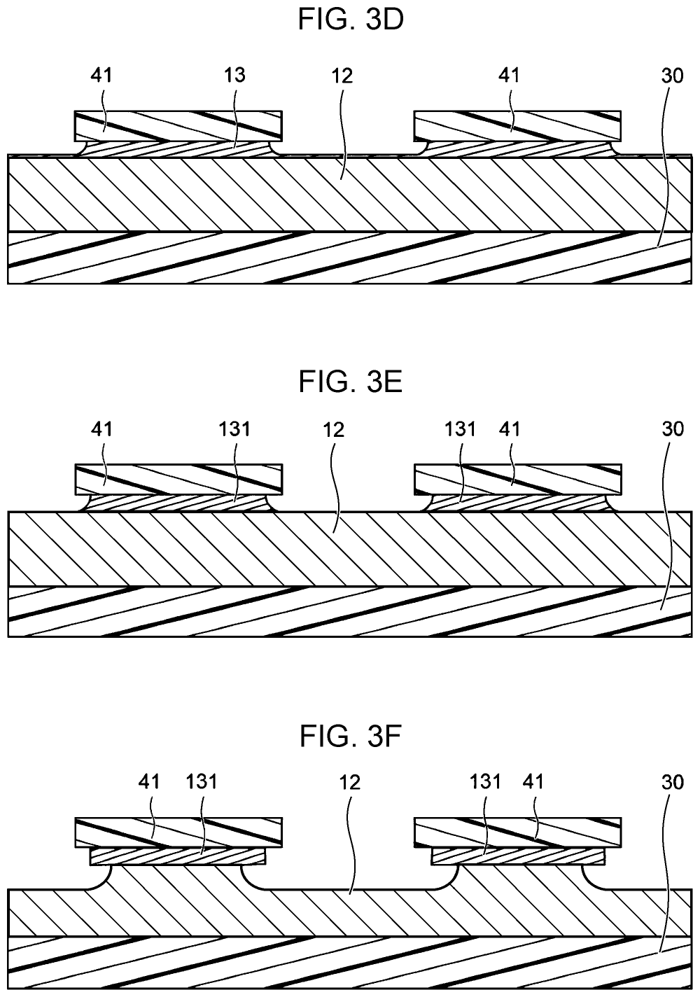

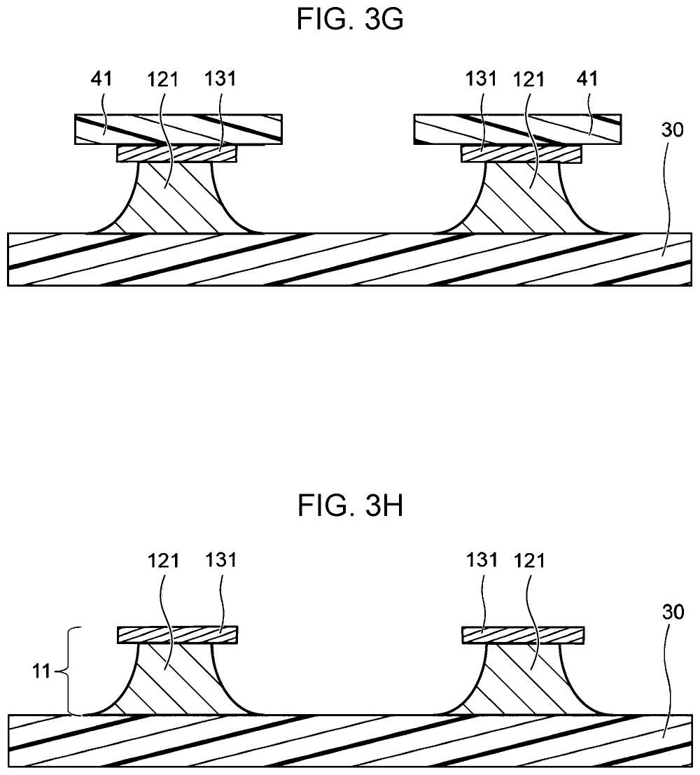

FIGS. 3A to 3H are explanatory views of a method for producing a strain gauge according to an embodiment of the present invention, and each illustrates the following states:

FIG. 3A: A state in which the strain resistance layer 12 and the protective layer 13 are laminated;

FIG. 3B: A state in which the resist film 40 is formed;

FIG. 3C: A state in which the resist pattern 41 is formed;

FIG. 3D: A state in which the protective layer 13 is being etched;

FIG. 3E: A state in which the protective layer 13 is etched to expose the strain resistance layer 12;

FIG. 3F: A state in which the strain resistance layer 12 is being etched;

FIG. 3G: A state in which etching of the strain resistance layer 12 is completed; and

FIG. 3H: A state in which the resist pattern 41 is removed.

In the production method according to the present embodiment, first, the protective layer 13 is formed on the strain resistance layer 12 disposed on the substrate 30 (FIG. 3A). This results in the formation of a laminated film in which the protective layer 13 is laminated on the strain resistance layer 12 on the substrate 30. The strain resistance layer 12 and the protective layer 13 can be produced in any production method. The film may be formed by a dry process, such as vapor deposition, sputtering, or reactive sputtering, or may be formed by a wet process, such as electroplating or electroless plating. When the strain resistance layer 12 and the protective layer 13 contains a main-group element, reactive sputtering, electroless plating, or the like may be preferably used.

After the laminated film is thus formed on the substrate 30, a resist film 40 is formed on the protective layer 13 of the laminated film (FIG. 3B). The resist film 40 may be formed by laminating a dry film resist, or may be formed by, for example, spin-coating a liquid resist.

The resist film 40 is subjected to a photolithography process (exposure and development) to form a resist pattern 41. This results in a state in which the resist pattern 41 is provided on the protective layer 13 (FIG. 3C).

A portion of the protective layer 13 not covered with the resist pattern 41 is then etched. This etching is typically wet etching using an etching solution. The etching solution is appropriately selected in accordance with the materials constituting the strain resistance layer 12, the protective layer 13, and the resist pattern 41. Specifically, the etching solution has the ability to dissolve the strain resistance layer 12. The etch rate of the strain resistance layer 12 is appropriately set in accordance with the fabrication process. For example, the etch rate when the strain resistance layer 12 is etched alone may be preferably 50 nm/min or more, more preferably 80 nm/min or more, and particularly preferably 100 nm/min or more.

The etching solution has the ability to dissolve the protective layer 13 as well. However, an etch rate as high as that needed for the strain resistance layer 12 is not needed. The etch rate of the protective layer 13 is appropriately set in accordance with the fabrication process. However, for example, the etch rate when the protective layer 13 is etched alone may be preferably 5 nm/min or more. As described below, in the producing method according to the present embodiment, since the protective layer 13 is in contact with the strain resistance layer 12, the etch rate thereof is lower than that when the protective layer 13 is etched alone.

Preferably, the etching solution does not easily etch the resist pattern 41. A specific example of such an etching solution is a cerium ammonium nitrate solution.

In wet etching, etching typically proceeds isotropically. Thus, when the etching solution etches the protective layer 13, as illustrated in FIG. 3D, the protective layer 13 is etched in the lamination direction, and the undercut of the protective layer 13 also occurs. As etching of the protective layer 13 in the stacking direction progresses, as illustrated in FIG. 3E, the strain resistance layer 12 is exposed in a region not covered with the resist pattern 41, and the unetched protective layer 13 is separated between the resist pattern 41 and the strain resistance layer 12 to provide a protective layer pattern 131.

When both the protective layer pattern 131 and the strain resistance layer 12 are exposed to the etching solution as illustrated in FIG. 3E, since the protective layer 13 (protective layer pattern 131) is electrochemically more noble than the strain resistance layer 12, a local cell is formed between them, decreasing the etch rate of the protective layer pattern 131. For this reason, the strain resistance layer 12 is preferentially etched, and the undercut occurring below the resist pattern 41 also proceeds preferentially in the strain resistance layer 12. As a result, as illustrated in FIG. 3F, the protective layer pattern 131 remains between the undercut portion of the strain resistance layer 12 and the resist pattern 41. This protective layer pattern 131 protects the resist pattern 41 from physical phenomena, such as generation of bubbles and localized and irregular fluctuations in the flow of the etching solution, caused by the undercut of the strain resistance layer 12. That is, the protective layer pattern 131 functions as a protective member for the resist pattern 41. Thus, the resist pattern 41 is less likely to be damaged during the wet etching. Specific examples of the damage include localized peeling, deformation, and loss of the resist pattern 41. Such damage causes the variations in the amount of undercut of the strain resistance layer 12.

In the production method according to the present embodiment, since the protective layer 13 (protective layer pattern 131) for protecting the resist pattern 41 is provided, when the etching in the lamination direction of the strain resistance layer 12 is completed to appropriately form a strain resistance layer pattern 121 as illustrated in FIG. 3G, the amount of the strain resistance layer 12 (strain resistance layer pattern 121) etched by the wet etching is less likely to vary.

The electrochemical protection of the protective layer pattern 131 is weakened when it is far from the contact area with the strain resistance layer 12. For this reason, the etch rate of the protective layer pattern 131 increases toward the end portions, and the protective layer pattern 131 is appropriately etched during etching of the strain resistance layer 12. Thus, when the resist pattern 41 is removed to form the pattern of the laminate 11 on the substrate 30, the protective layer pattern 131 is less likely to protrude horizontally from the strain resistance layer pattern 121 (FIG. 3H).

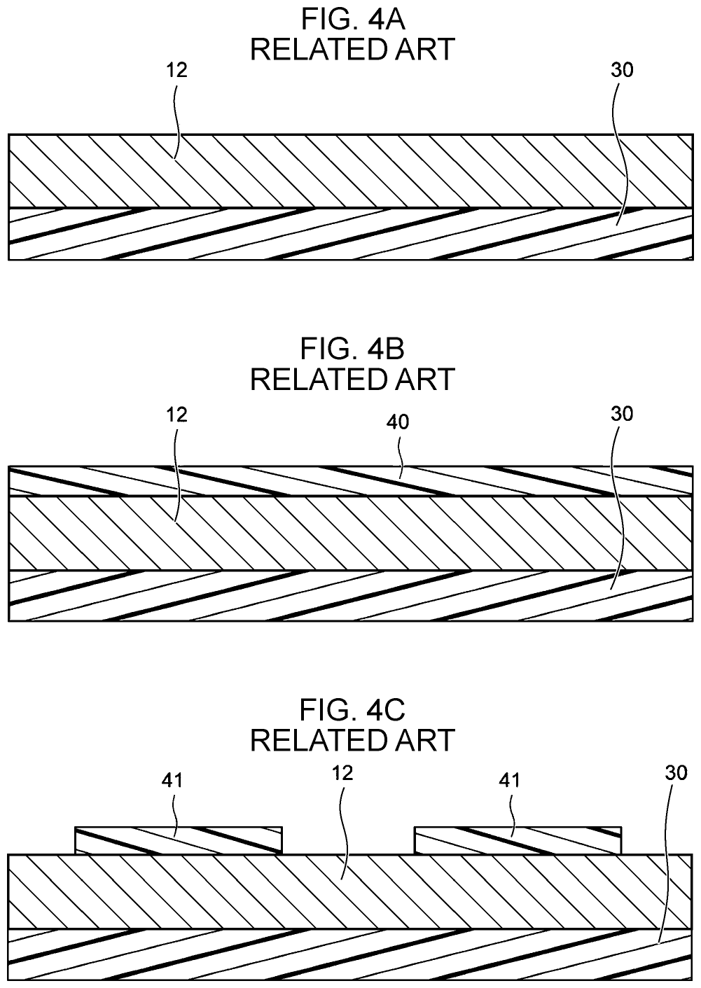

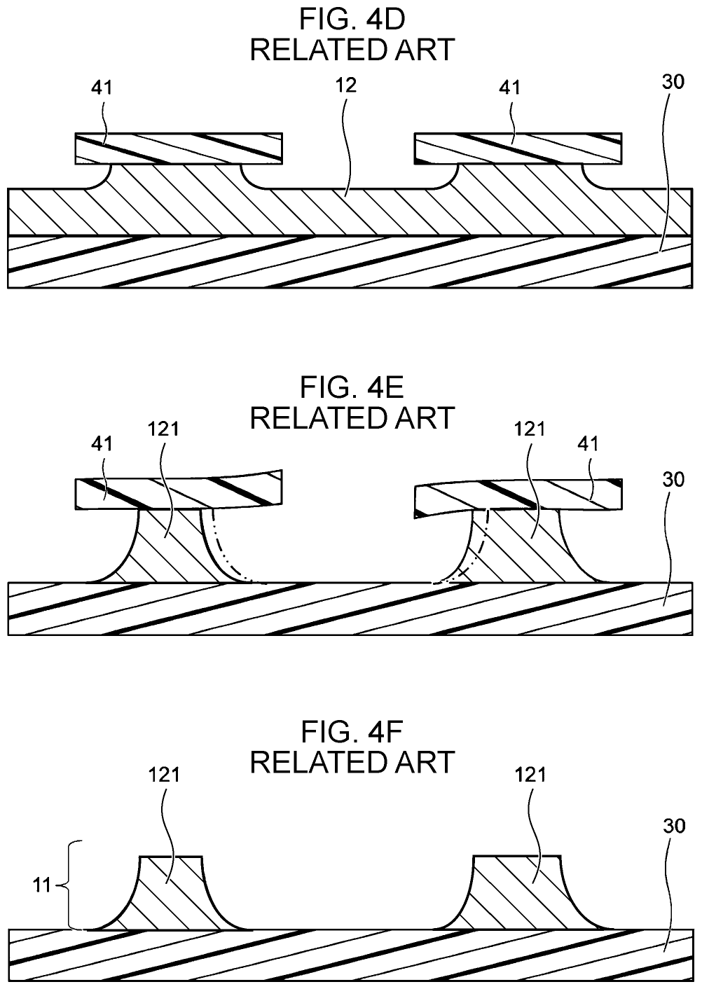

FIG. 4A is an explanatory view of a method for producing a strain gauge according to the related art and illustrates a state in which a strain resistance layer is laminated. FIG. 4B is an explanatory view of the method for producing a strain gauge according to the related art and illustrates a state in which a resist film is formed. FIG. 4C is an explanatory view of the method for producing a strain gauge according to the related art and illustrates a state in which a resist pattern is formed. FIG. 4D is an explanatory view of the method for producing a strain gauge according to the related art and illustrates a state in which the strain resistance layer is being etched. FIG. 4E is an explanatory view of the method for producing a strain gauge according to the related art and illustrates a state in which etching of the strain resistance layer is completed. FIG. 4F is an explanatory view of the method for producing a strain gauge according to the related art and illustrates a state in which the resist pattern is removed.

In the production method according to the related art, the protective layer 13 provided in the production method according to the present embodiment is not formed on the strain resistance layer 12 on the substrate 30, and instead a resist film 40 is formed thereon (FIGS. 4A and 4B). Therefore, the resist pattern 41 formed by photolithography is disposed so as to be in contact with the strain resistance layer 12 (FIG. 4C).

When wet etching is performed with an etching solution in this state, the undercut of the strain resistance layer 12 occurs directly below the resist pattern 41 (FIG. 4D). The dissolution reaction of the strain resistance layer 12 results in the undercut and is accompanied by the generation of a gas and so forth. This causes local and irregular fluctuations in the flow of the etching solution near the contact interface between the resist pattern 41 and the strain resistance layer 12. In the production method according to the related art, due to this uncontrollable physical phenomenon, the amount of undercut of the strain resistance layer 12 varies greatly, as conceptually illustrated in FIG. 4E. Dot-dot-dash lines in FIG. 4E conceptually illustrate the results of the undercut when variations are small.

For the above reasons, in the production method according to the related art, the strain resistance layer pattern 121 formed on the substrate 30 has large variations in shape. In Japanese Unexamined Patent Application Publication No. 2016-74934, variations in the sensitivity of the strain gauge are so large that a resistive wiring pattern for resistance adjustment is required.

The above embodiments are described in order to facilitate understanding of the present invention and are not intended to limit the present invention. Therefore, the elements disclosed in the above embodiments involve all design changes and equivalents that fall within the technical scope of the present invention.

The present invention will be described in detail with reference to examples.

### EXAMPLES

### Example 1

The strain gauges 10 were produced based on the production method illustrated in FIGS. 3A to 3H. The details of the components, such as the strain resistance layer 12 and the protective layer 13, and the production method are described below.
Substrate 30: Polyimide film
Strain resistance layer 12: In each of the following examples, the layer was formed by sputtering as follows:
   NiCr₂₀, thickness: 140 nm
   CuNi₄₅, thickness: 70 nm
   Cr, thickness: 35 nm
Protective layer 13: In each of the following examples, the layer was formed by sputtering with a thickness of 10 nm.
   CrB₁₅
   CrC₁₅
   CrSi₁₅
   CrGe₁₅
   Cr
   CrTi₁₅
   Ta
Resist film 40: Formed by spin-coating a liquid resist.
Etching solution: Cerium ammonium nitrate solution

Table 1 presents the etch rate (unit: μm/min) and the resistivity (unit: μmΩcm) of each layer when each layer was etched individually with the above etching solution. The protective layer 13 composed of Ta could not be etched with the above etching solution, and were etched by a dry process (reactive ion etching).

TABLE 1

| | Etch rate | |
|---|---|---|
| Layer | (nm/min) | Resistivity (μΩcm) |
| CrB₁₅ | 8.6 | 155 |
| CrC₁₅ | 7.4 | 182 |
| CrSi₁₅ | 9.4 | 182 |
| CrP₁₅ | 8.2 | 165 |
| CrGe₁₅ | 10.2 | 174 |
| NiCr₂₀ | 131 | 104 |
| CuNi₄₅ | 148 | 48 |
| Cr | 87 | 25 |

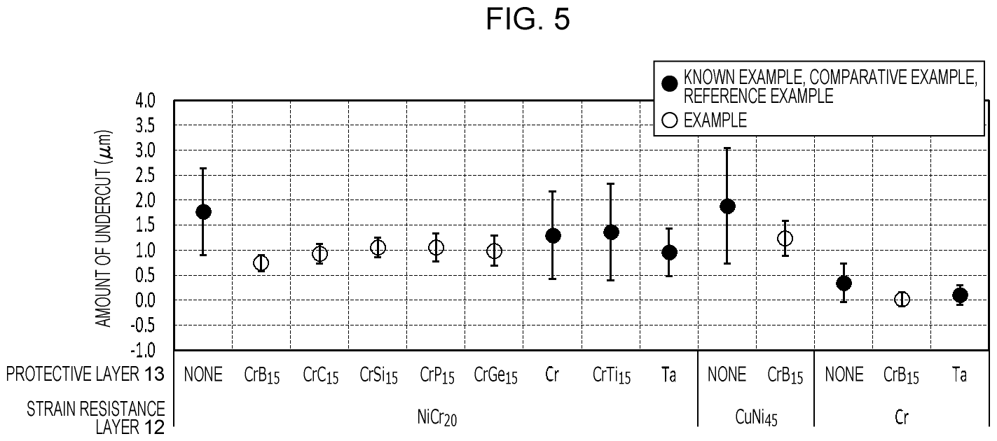

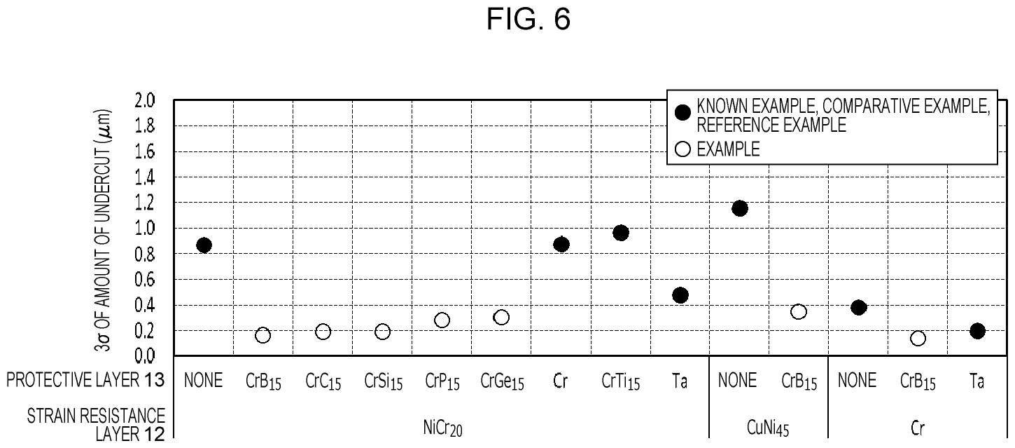

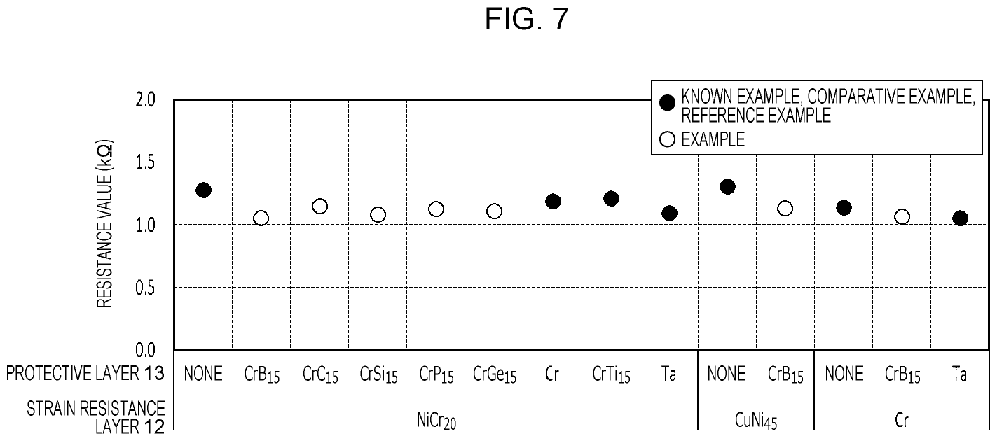

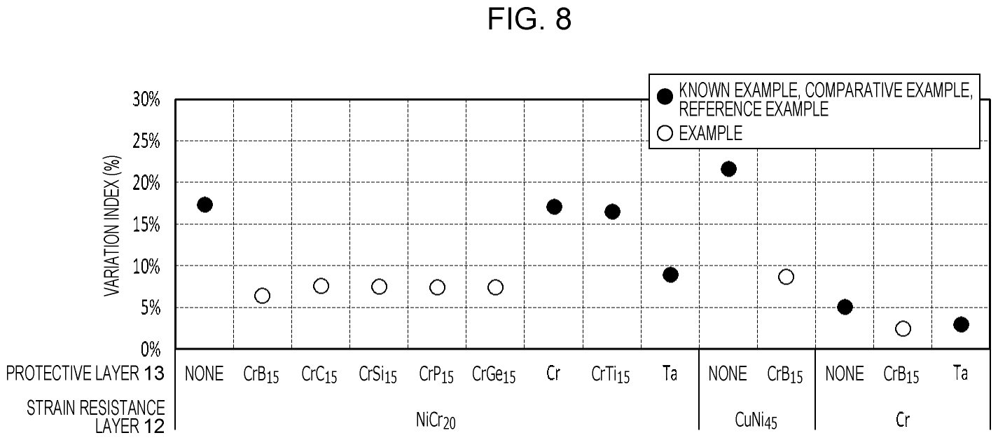

The amount of undercut (unit: μm) of strain resistance layer 12 of the resulting laminates 11 was measured (in each example, the number of measured samples was 80), and the mean value and 3σ, which is three times the standard deviation, were calculated. The interelectrode resistance (unit: kΩ) of the strain gauges 10 was measured (in each example, the number of measured samples was 80), and the mean value, 3σ, and 3σ/mean value (unit: %, referred to in the present specification as “variation index”) were calculated. The gauge factor Gf of the strain gauge 10 was also measured. The measurement results are presented in Table 2 and FIGS. 5 to 8.

TABLE 2

| | | | Amount Of | | | | | | |
|---|---|---|---|---|---|---|---|---|---|
| | Strain | | Undercut (μm) | | Resistance Value | | Applicability | | |
| | Resistance | Protective | Mean | | Mean | Variation | of Batch Wet | Gauge | |
| Example | Layer | Layer | Value | 3σ | Value (Kω) | Index (%) | Etching | Factor | Remarks |
| 1-1 | NiCr₂₀ | none | 1.77 | 0.87 | 1.28 | 17.41% | Yes | 2.39 | Known |
| | | | | | | | | | Example |
| 1-2 | | CrB₁₅ | 0.74 | 0.16 | 1.05 | 6.45% | Yes | 2.34 | Example |
| 1-3 | | CrC₁₅ | 0.93 | 0.19 | 1.15 | 7.62% | Yes | 2.37 | Example |
| 1-4 | | CrSi₁₅ | 1.06 | 0.19 | 1.08 | 7.51% | Yes | 2.32 | Example |
| 1-5 | | CrP₁₅ | 1.06 | 0.28 | 1.13 | 7.46% | Yes | 2.33 | Example |
| 1-6 | | CrGe₁₅ | 0.99 | 0.30 | 1.11 | 7.41% | Yes | 2.35 | Example |
| 1-7 | | Cr | 1.29 | 0.88 | 1.19 | 17.14% | Yes | 2.86 | Comparative |
| | | | | | | | | | Example |
| 1-8 | | CrTi₁₅ | 1.37 | 0.97 | 1.21 | 16.51% | Yes | 2.30 | Comparative |
| | | | | | | | | | Example |
| 1-9 | | Ta | 0.96 | 0.48 | 1.10 | 8.94% | No | 2.32 | Reference |
| | | | | | | | | | Example |
| 1-10 | CuNi₄₅ | none | 1.89 | 1.16 | 1.31 | 21.67% | Yes | 2.18 | Known |
| | | | | | | | | | Example |
| 1-11 | | CrB₁₅ | 1.24 | 0.35 | 1.13 | 8.68% | Yes | 2.12 | Example |
| 1-12 | Cr | none | 0.34 | 0.38 | 1.14 | 5.10% | Yes | 8.64 | Known |
| | | | | | | | | | Example |
| 1-13 | | CrB₁₅ | 0.01 | 0.14 | 1.06 | 2.51% | Yes | 9.18 | Example |
| 1-14 | | Ta | 0.10 | 0.20 | 1.06 | 3.00% | No | 9.21 | Reference |
| | | | | | | | | | Example |

Table 2 and so forth indicate that when the protective layer 13 was electrochemically more noble than the strain resistance layer 12 (Examples 1-2 to 1-6, 1-11, and 1-13), the variations (3σ) in the amount of undercut were smaller than when the protective layer 13 was not provided (Examples 1-1, 1-10, and 1-12) and when the protective layer 13 was not electrochemically more noble than the strain resistance layer 12 (Examples 1-7 and 1-8). The results also indicate that when the protective layer 13 was provided, the variations (variation indices) in the resistance values of the strain gauges 10 were also reduced. When the protective layer 13 was composed of Ta (Examples 1-9 and 1-14), the protective layer 13 could not be processed with the etching solution used in the examples, and therefore this is considered a reference example.

### Example 2

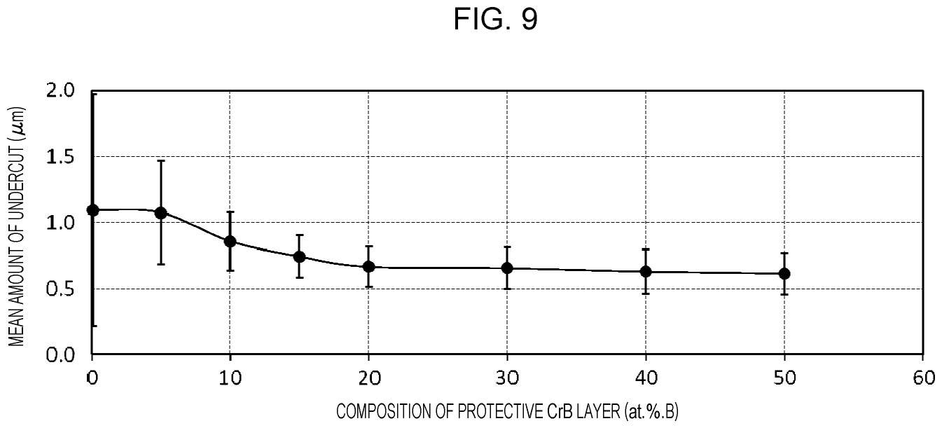

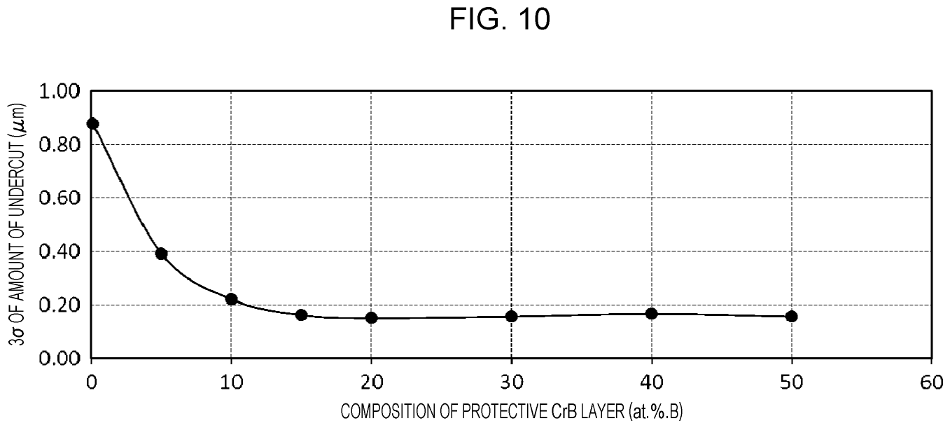

Strain gauges 10 were produced by the same production method as in Example 1, except that the material of each strain resistance layer 12 was NiCr₂₀, and the material of each protective layer 13 was CrBₓ, where x was in the range of 0 to 60. The amount of undercut (unit: μm) of each of the strain resistance layers 12 (the number of measurements in each example: 80) of the laminates 11 of the resulting strain gauges 10 was measured, and the mean value and 3σ, which is three times the standard deviation, were calculated. The results are presented in Table 3 and in FIGS. 9 and 10.

TABLE 3

| | | | Amount Of | | | |
|---|---|---|---|---|---|---|
| | Strain | Composition of | Undercut (μm) | | Applicability | |
| | Resistance | Protective Crb | Mean | | of Batch Wet | |
| Example | Layer | Layer (At · % · B) | Value | 3σ | Etching | Remarks |
| 2-1 | NiCr₂₀ | 0 | 1.09 | 0.88 | yes | Known |
| | | | | | | Example |
| 2-2 | | 5 | 1.07 | 0.39 | yes | Example |
| 2-3 | | 10 | 0.86 | 0.22 | yes | Example |
| 2-4 | | 15 | 0.74 | 0.16 | yes | Example |
| 2-5 | | 20 | 0.67 | 0.15 | yes | Example |
| 2-6 | | 30 | 0.65 | 0.16 | yes | Example |
| 2-7 | | 40 | 0.63 | 0.17 | yes | Example |
| 2-8 | | 50 | 0.61 | 0.16 | yes | Example |
| 2-9 | | 60 | — | — | no | Reference |
| | | | | | | Example |

Table 3 and so forth indicate that when X in CrBₓ of the protective layer 13 was 5 at. % (Example 2-2), the variations (3σ) in the amount of undercut were significantly reduced, compared with when the protective layer 13 did not contain B (Example 2-1). When the amount of B added to the protective layer 13 composed of CrBₓ was increased, the variations (3σ) in the amount of undercut were further reduced. The degree of reduction was more gradual than in the cases of Example 2-1 and Example 2-2. The results indicated that the incorporation of B into the protective layer 13 to reverse the electrochemical noble-base relationship between the strain resistance layer 12 and the protective layer 13 had the greatest effect on reducing the variations (30) in the amount of undercut. The present examples indicated that from the viewpoint of reducing the variations (3σ) in the amount of undercut, it was sufficient that the amount of B added to the protective layer 13 was 20 at. %, and even when the production variations in the formation of the protective layer 13 were taken into consideration, it was sufficient that the amount of B added was 25 at. %. When X in CrBx is 60 at. %, the metallic properties of the protective layer 13 were excessively reduced, and the protective layer 13 could not be etched with the etching solution. Thus, this was used as a reference example.

1. A strain gauge, comprising:
a patterned laminate including:
a strain resistance layer; and
a protective layer having a portion in contact with the strain resistance layer,
wherein the protective layer is electrochemically more noble than the strain resistance layer.

2. The strain gauge according to claim 1, wherein the protective layer has a higher resistivity than that of the strain resistance layer.

3. The strain gauge according to claim 1, wherein the protective layer is etchable with an etching solution for etching the strain resistance layer.

4. The strain gauge according to claim 1,
wherein the strain resistance layer contains at least one first element selected from the group consisting of Ni, Cr, and Cu,
and wherein the protective layer contains:
at least one second element selected from the group consisting of Ni and Cr; and
at least one third element having a first ionization energy higher than that of the at least one first element contained in the strain resistance layer with a highest content (unit: at. %).

5. The strain gauge according to claim 4, wherein an amount of the at least one third element contained in the protective layer is 50 at. % or less.

6. The strain gauge according to claim 4, wherein an amount of the at least one third element contained in the protective layer is 10 at. % or more.

7. The strain gauge according to claim 4, wherein the at least one third element includes a metalloid element or a main-group element.

8. The strain gauge according to claim 4, wherein the at least one third element includes at least one element selected from the group consisting of B, C, Si, P, and Ge.

9. The strain gauge according to claim 4, wherein the at least one third element has a Pauling electronegativity of 2.6 or less.

10. The strain gauge according to claim 4, wherein the at least one first element contains Cr, and the strain resistance layer further contains a main-group element.

11. The strain gauge according to claim 10, wherein the strain resistance layer has a resistivity of 100 μΩcm or less, which is lower than a resistivity of the protective layer.

12. A strain sensor, comprising:
a strain gauge according to claim 1; and
an electrode for energizing the strain gauge.

13. A method for producing a strain gauge having a patterned laminate, the method comprising:
forming the patterned laminate, including:
forming a protective layer on a strain resistance layer disposed on a substrate, the protective layer being electrochemically more noble than the strain resistance layer;
forming a resist pattern on the protective layer, and
performing wet etching, thereby removing an exposed portion of the protective layer which is not covered with the resist pattern and a portion of the strain resistance layer located below the exposed portion of the protective layer.

14. The method for producing a strain gauge according to claim 13, wherein an etch rate of the strain resistance layer in an etching solution used for the wet etching is 50 nm/min or more.

15. The method for producing a strain gauge according to claim 13, wherein an etch rate of the protective layer in an etching solution used for the wet etching is 5 nm/min or more.

16. The method for producing a strain gauge according to claim 13, wherein the forming the patterned laminate further includes:
removing the resist pattern after the performing wet etching, thereby producing the pattered laminate disposed on the substrate.

17. The method for producing a strain gauge according to claim 13, wherein the wet etching includes:
forming a protective layer pattern corresponding to the resist pattern; and
forming a strain resistance layer pattern corresponding to the resist pattern, during which undercuts are formed below the patterned protective layer, while the patterned protective layer protects the resist pattern from etching damages.
